(19) United States
(12) Patent Application Publication
(10) Pub. No.: US 2007/0151423 A1
(43) Pub. Date: Jul. 5, 2007

(54) Apparatus of reverse ratchet wrench to indicate the driving orientation

(75) Inventor: Arthur Wu, Taichung Hsien (TW)

Correspondence Address: BIRCH STEWART KOLASCH & BIRCH, PO BOX 747, FALLS CHURCH, VA, 22040-0747, US

(73) Assignee: Proxene Tools Co., LTD.

(21) Appl. No.: 11/320,762

(22) Filed: Dec. 30, 2005

(51) Int. Cl. B25B 13/46

(52) U.S. Cl. 81/63.1

(57) ABSTRACT

A ratchet wrench includes a handle with a head portion at an end thereof, a ratchet wheel mounted in the head portion for rotation and an operating device to be moved between a first position and a second position for change of a driving orientation of the ratchet wrench. The operating device has a mask member, and the handle has a first indicating member and a second indicating member. The second indicating member is hidden under the mask member of the operating device and the first indicating member is exposed when the operating device is moved to the first position, and the first indicating member is hidden under the mask member of the operating device and the second indicating member is exposed when the operating device is moved to the second position to tell user the driving orientation of the wrench.

### BACKGROUND OF THE INVENTION

1. Field of the Invention

The present invention relates generally to a hand tool, and more particularly to a reverse ratchet wrench, which is able to indicate the driving orientation of the wrench.

2. Description of the Related Art

Conventional reverse ratchet wrenches have a ratchet wheel, a pawl and a level. User may move the level to move the pawl, and the pawl will be detachably meshed the ratchet wheel at a right or life side, such that the ratchet wrench can turn a bolt (or nut) tight or loose repeatedly in a condition that the wrench engages the bolt (or nut) always.

There is no movement compatibility between the movement of the level and the driving direction of the ratchet wrench, such that user always confuses which direction to move the level when he/she wants to turn loose (or turn tight) the bolt or nut. Most of them use try-and-error method, which means user moves the level to one position first and turn the wrench. If it not the driving direction that the user wants than move the level to another position. And user always forgets which way to turn loose and which way to turn tight every time he/she uses the wrench.

Taiwan Pat. Publication No. 502944 disclosed a ratchet wrench having an unsymmetrical head. Taiwan Pat. Publication No 501519 disclosed a wrench with texture, arrow or mark on a side of the handle. Many conventional ratchet wrenches have characters beside the level to indicate the driving direction. It usually puts “R” for release and “L” for lock. But user might misunderstand or miss the meaning of the signs for indication, so that many users will ignore the signs and determine the driving direction by try-and-error.

U.S. Pat. No. 5,548,903 provides an adjustable wrench, which has a window to show the size of the nut held by the wrench, and this patent is different from the present invention in objective.

### SUMMARY OF THE INVENTION

The primary objective of the present invention is to provide a ratchet wrench, which is able to show user the driving orientation of the wrench.

According to the objective of the present invention, a ratchet wrench includes a handle with a head portion at an end thereof, a ratchet wheel mounted in the head portion for rotation and an operating device to be moved between a first position and a second position for change of a driving orientation of the ratchet wrench, wherein the operating device has a mask member, and the handle has a first indicating member and a second indicating member, such that the second indicating member is hidden under the mask member of the operating device and the first indicating member is exposed when the operating device is moved to the first position, and the first indicating member is hidden under the mask member of the operating device and the second indicating member is exposed when the operating device is moved to the second position.

### BRIEF DESCRIPTION OF THE DRAWINGS

FIG. 1 is a sectional view of a first preferred embodiment of the present invention;

FIG. 2 is a top view of the first preferred embodiment of the present invention, showing the operating device being moved to the first position to expose the first indicating member;

FIG. 3 is a top view of the first preferred embodiment of the present invention, showing the operating device being moved to the second position to expose the second indicating member;

FIG. 4 is a top view of a second preferred embodiment of the present invention, showing the operating device being moved to the first position to expose the first indicating member;

FIG. 5 is a top view of the second preferred embodiment of the present invention, showing the operating device being moved to the second position to expose the second indicating member;

FIG. 6 is a top view of a second preferred embodiment of the present invention, showing the operating device being moved to the first position to expose the first indicating member; and

FIG. 7 is a top view of the second preferred embodiment of the present invention, showing the operating device being moved to the second position to expose the second indicating member.

### DETAILED DESCRIPTION OF THE INVENTION

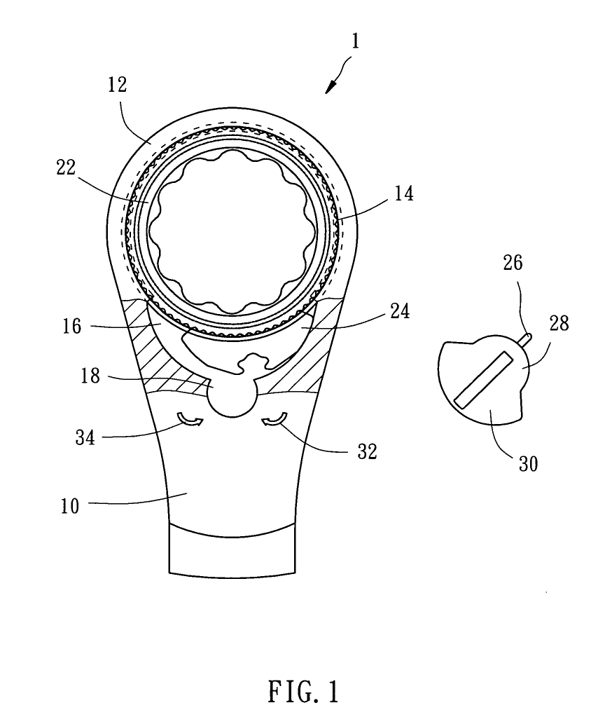

As shown in FIG. 1, a ratchet wrench 1 of the first preferred embodiment of the present invention includes a handle 10, a ratchet wheel 22, a pawl 24, a switching device 26 and an operating device 28.

The handle 10 has a head portion 12 at an end thereof, on which a first chamber 14, a second chamber 16, and a third chamber 18 are provided. The first, second and third chambers 14, 16 and 18 are communicated with each other, and the second chamber 16 is between the first chamber 14 and the third chamber 18.

The ratchet wheel 22 is received in the first chamber 14 of the handle 10 for free rotation.

The pawl 24 is received in the second chamber 16 to be moved to a right or left of the second chamber 16. The pawl 24 is able to be meshed and unmeshed with the ratchet wheel 22.

The switching device 26 is mounted in the third chamber 18 to elastically pushing the pawl 24.

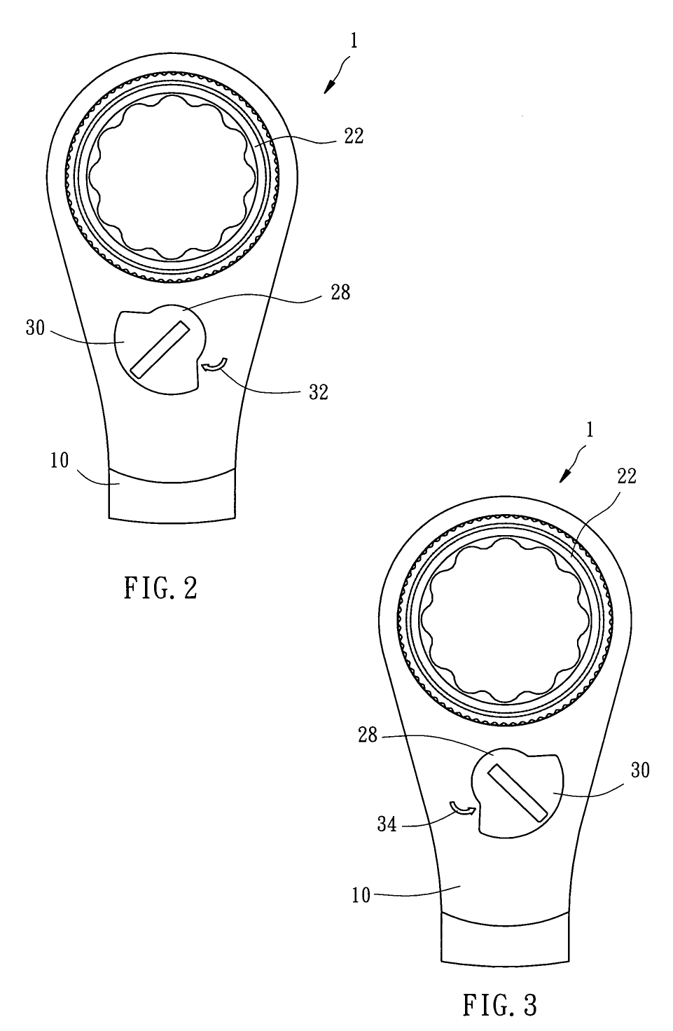

The operating device 34 is connected to the switching device 26 to be turned between a first position (FIG. 2) and a second position (FIG. 3). When turning the operating device 34, the switching device 26 will be rotated to move the pawl 24 to the right or left of the second chamber 16. As a result, the ratchet wrench 1 may turn tight or turn loose a bolt (not shown).

Above description is as same as the conventional ratchet wrench, and the new part of the present invention is described hereunder.

As shown in FIG. 2 and FIG. 3, the handle 10 is provided with a first indicating member 32 and a second indicating member 34 on the head portion 12. In the present invention, the indicating members 32 and 34 are two pieces of arrow-like stamps stuck on the handle 10 pointing to opposite orientations. The indicating members 32 and 34 also may be made by laser, stamping, printing, coating, and the relative method. The stamps are printed with fluorescence paint, such that it will light in dark environment. The operating device 28 has a mask member 30, and the mask member 30 is moved to a position above the second indicating member 34 when the operating device 28 is moved to the first position (referring to FIG. 2), and the mask member 30 is moved to a position above the first indicating member 32 when the operating device 28 is moved to the second position (referring to FIG. 3). As a result, user will see the first indicating member 32 only when the operating device 28 is moved to the first position (FIG. 2), and see second indicating member 34 only when the operating device 28 is moved to the second position (FIG. 3). The arrows of the indicating members 32 and 34 inform user the driving orientation of the ratchet wrench 1 of the present invention. The indicating members 32 and 34 will show up and disappear when the operating device 28 is moved, so that it will attract user's attention and user will tell which is to turn tight and which is to turn loose.

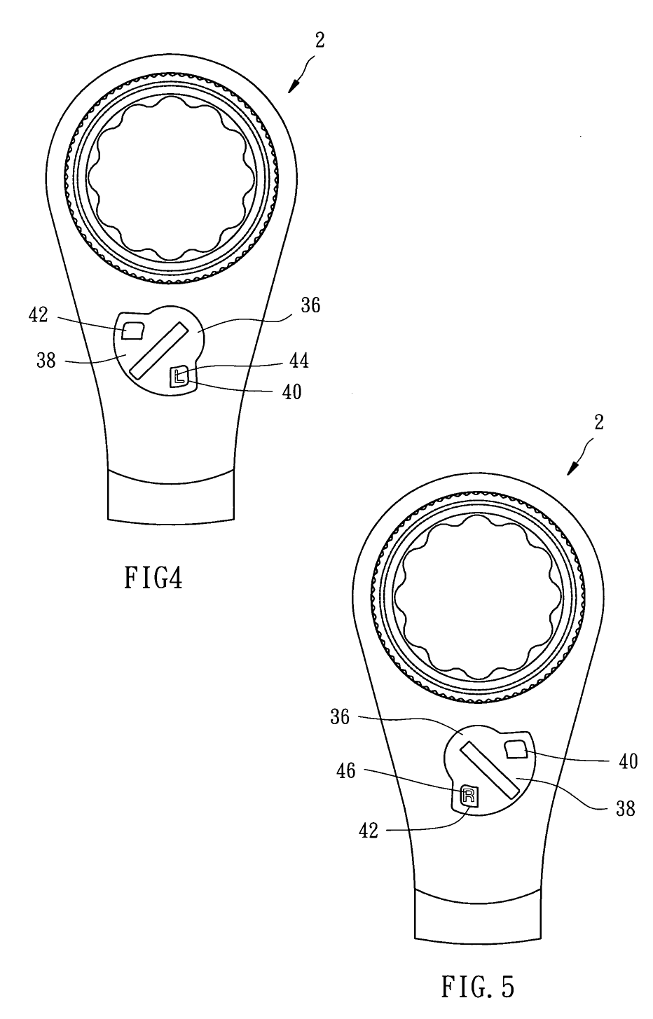

As shown in FIG. 4 and FIG. 5, a ratchet wrench 2 of the second preferred embodiment of the present invention, which main structure is similar to the ratchet wrench 1 of the first preferred embodiment, includes an operating device 36 for manipulation to change the driving orientation of the ratchet wrench 2. The operating device 36 has a mask member 38, on which a first window 40 and a second window 42 are provided. The ratchet wrench 2 is provided with a first indicating member 44, which is a red character “L”, and a second indicating member 46, which is a green character “R”. “L” means “Lock”, and “R” means “Release”.

When the operating device 36 is moved to the first position, the first indicating member 44, the red character “L”, is showing up via the first window 40, and when the operating device 36 is moved to the second position, the first indicating member 44 is hidden by the mask member 38 and the second indicating member 46, the green “R”, is showing up via the second window 42. The colors of the characters also give a “redundant signal” that user may tell the driving orientation by the color as well.

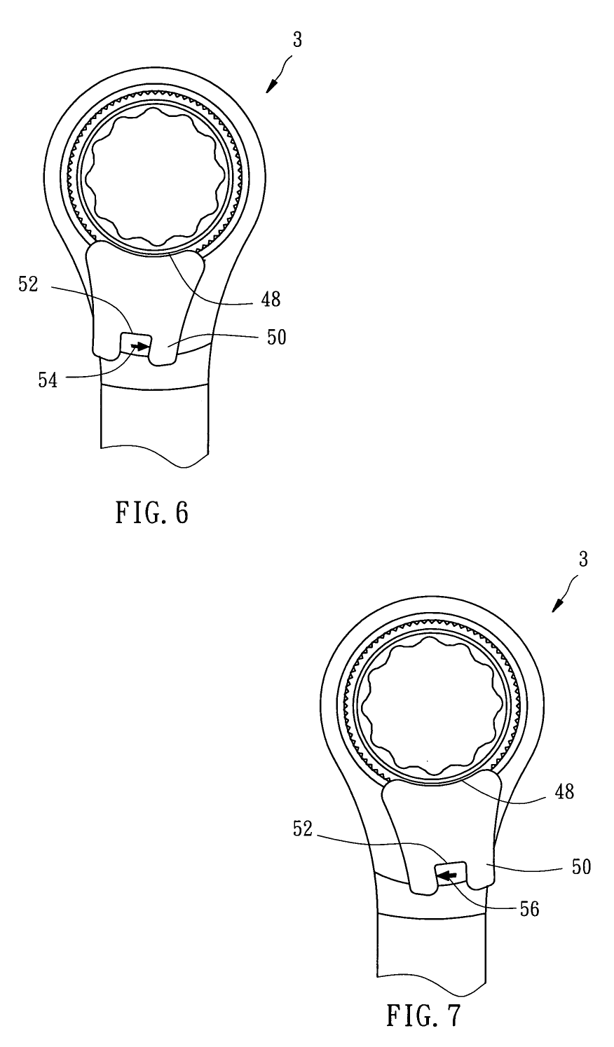

FIG. 6 and FIG. 7 show a ratchet wrench 3 of the third preferred embodiment of the present invention, which includes an operating device 48 for manipulation to change the driving orientation of the ratchet wrench 3. The operating device 48 has a mask member 50, on which a window 52 is provided. The ratchet wrench 3 is provided with a first indicating member 54 and a second indicating member 56, which are two arrows pointing to opposite directions.

When the operating device 48 is moved to the first position, referring to FIG. 6, the first indicating member 54 is showing up via the window 52, and when the operating device 48 is moved to the second position, referring to FIG. 7, the first indicating member 54 is hidden by the operating device 48 and the second indicating member 56 is showing up via the window 52.

Referring to FIG. 2 and FIG. 4 of the present invention, when the operating device is moved to the first position, the ratchet wrench drives the bolt (or nut) for clockwise rotation to turn it tight. The common fasteners are right thread. FIG. 6 shows the opposite driving direction. It may tell that the reverse ratchet wrench has no movement compatibility between the movement of the operating device and the driving direction. It always confuses user.

The main character of the present invention is to expose the predetermined indicating member and hide the other one when the operating device is move to the predetermined position. By showing-up/disappearing of the indicating member, it will catch user's attention. In addition, the indicating member may use fluorescent paint to emit fluorescence in the dark that helps indication propose when user work in a dark workplace, such as repairing cars.

1. A ratchet wrench, comprising:
a handle with a head portion at an end thereof,
a ratchet wheel mounted in the head portion for rotation, and
an operating device to be moved between a first position and a second position for change of a driving orientation of the ratchet wrench,
the operating device having a mask member, and the handle having a first indicating member and a second indicating member,
the second indicating member being hidden under the mask member of the operating device and the first indicating member being exposed when the operating device is moved to the first position, and the first indicating member being hidden under the mask member of the operating device and the second indicating member being exposed when the operating device is moved to the second position.

2. The ratchet wrench as defined in claim 1, wherein the first indicating member and the second indicating member are two arrows pointing to opposite directions.

3. The ratchet wrench as defined in claim 1, wherein the first indicating member and the second indicating member are two icons or characters.

4. The ratchet wrench as defined in claim 1, wherein the first indicating member and the second indicating member have different colors.

5. The ratchet wrench as defined in claim 1, wherein the first indicating member and the second indicating member emit fluorescence.

6. The ratchet wrench as defined in claim 1, wherein the operating device has a window on the mask member, the first indicating member being exposed via the window when the operating device is moved to the first position, and the second indicating member being exposed via the window when the operating device is moved to the second position.

7. The ratchet wrench as defined in claim 1, wherein the operating device has a first window and a second window on the mask member, the first indicating member being exposed via the first window when the operating device is moved to the first position, and the second indicating member being exposed via the second window when the operating device is moved to the second position.

8. The ratchet wrench as defined in claim 1, wherein the first indicating member and the second indicating member are provided on the handle by laser.

9. The ratchet wrench as defined in claim 1, wherein the first indicating member and the second indicating member are provided on the handle by stamping.

10. The ratchet wrench as defined in claim 1, wherein the first indicating member and the second indicating member are provided on the handle by printing or coating.

11. The ratchet wrench as defined in claim 9, wherein the first indicating member and the second indicating member are two pieces of stamps struck on the handle.

12. The ratchet wrench as defined in claim 11, wherein the stamps are printed with fluorescent paint.
